(19) United States
(12) Patent Application Publication
(10) Pub. No.: US 2025/0010303 A1
(43) Pub. Date: Jan. 9, 2025

(54) SYSTEMS AND METHODS FOR ATP TESTING

(71) Applicant: Empire Bio Diagnostics Corp., Hicksville, NY (US)

(72) Inventors: Farooq Waheed Rauf WAHEED, Hicksville, NY (US); Douglas J. MACKAY, Hicksville, NY (US)

(21) Appl. No.: 18/750,804

(22) Filed: Jun. 21, 2024

Related U.S. Application Data
(60) Provisional application No. 63/522,545, filed on Jun. 22, 2023.

(51) Int. Cl. B01L 3/00; G01N 1/02

(52) U.S. Cl. CPC B01L 3/5029; B01L 3/5023; G01N 1/02; B01L 2200/12; B01L 2200/16; B01L 2300/042; B01L 2300/044; G01N 2001/028

(57) ABSTRACT

The disclosed test collection device contains reagents and a testing swab. The device has a first configuration allowing easy disassembly of a tube section from a venturi, allowing a swab to be withdrawn for sample collection. The test collection device can then be reassembled with the swab and advanced to a second configuration, where reagents mix with the sample, and then processed. The second configuration securely contains the sample so that escape and contamination is lessened. Methods for assembling a test collection device and methods for using a test collection device are described.

### TECHNICAL FIELD

Some applications of the present invention relate to devices and methods for performing diagnostic testing. More specifically, some applications of the present invention relate to the use of disposable devices for collecting samples for adenosine triphosphate (ATP) testing.

### BACKGROUND

Hygiene monitoring in healthcare settings reduces the risk of spread of infections and other illness. Environmental surfaces in healthcare, food processing and other sensitive environments requiring high levels of sterility are frequently subject to ATP testing. ATP testing is an evidence-based modality that measures the level of ATP on a surface and correlates that measured level to microorganism activity. A level above a certain threshold would indicate the need for cleaning or sterilizing the tested environmental surface.

Prior art ATP tests frequently utilize some type of test collection device, such as a swab, which is wiped over an environmental surface. The swab is then placed into a vial or test tube containing a testing solution. The vial is then read with a luminometer to determine ATP levels.

### SUMMARY

Disclosed devices and methods provide an improved collection device for use in ATP testing. The embodiments of the present disclosure include devices and methods for providing enhanced ATP testing of environmental surfaces while protecting environmental services and other personnel involved in testing from risk of exposure to environmental hazards contained in an environmental sample.

Prior art ATP test collection devices, or consumables, are known to have a deficiency when it comes to protecting and isolating the sample once introduced into the test tube. This shortcoming becomes more problematic when it comes to collecting and testing samples that may have traces of bacteria or virus that may be harmful to humans if spilled or otherwise released.

According to one embodiment of the present disclosure, the prior art ATP consumable is improved by creating an interlocking system to ensure that the venturi and the test tube are interlocked and cannot be separated once the sample is collected and tested and hence making it very easy to dispose the sample safely.

Additional objects and advantages of the embodiments will be set forth in part in the description that follows, and in part will be obvious from the description or may be learned by practice of the embodiments. The objects and advantages of the embodiments will be realized and attained by means of the elements and combinations particularly pointed out in the appended claims.

It is to be understood that both the foregoing general description and the following detailed description are exemplary and explanatory only and are not restrictive of the claims.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1 illustrates an exemplary collection device, consistent with some embodiments of the present disclosure.

FIG. 2 illustrates an exploded view of the exemplary collection device of FIG. 1, consistent with some embodiments of the present disclosure.

FIGS. 3A, 3B and 3C depict exemplary views of a venturi, consistent with some embodiments of the present disclosure.

FIG. 4 depicts an exemplary view of a tube upper section, consistent with disclosed embodiments.

FIG. 5 depicts an exemplary view of a lower tube cap, consistent with some embodiments of the present disclosure.

FIGS. 6A, 6B and 6C depict exemplary views of a nib, consistent with some embodiments of the present disclosure.

FIGS. 7A, 7B, 7C and 7D depict exemplary views of a tube upper section and lower tube cap, consistent with some embodiments of the present disclosure.

FIGS. 8A, 8B and 8C depict exemplary views of a tube assembly in a first, transport configuration, consistent with some embodiments of the present disclosure.

FIG. 9 depicts an exemplary view of a tube assembly in a second, function configuration, consistent with some embodiments of the present disclosure.

FIG. 10 depicts a flowchart of an exemplary process of assembling the exemplary collection device of FIG. 1, consistent with some embodiments of the present disclosure.

FIG. 11 depicts a flowchart of an exemplary process of using the exemplary collection device of FIG. 1 for testing, consistent with some embodiments of the present disclosure.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures can be rearranged, combined, or divided without departing from the envisioned embodiments. Similarly, additional steps may be added, or steps may be removed, without departing from the envisioned embodiments. Thus, the materials, methods, and examples are illustrative only and are not intended to be necessarily limiting.

Exemplary embodiments are described with reference to the accompanying drawings. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It should also be noted that as used herein and in the appended claims, the singular forms “a,” “an,” and “the” include plural references unless the context clearly dictates otherwise.

In the following description, various working examples are provided for illustrative purposes. However, is to be understood the present disclosure may be practiced without one or more of these details.

This disclosure is provided for the convenience of the reader to provide a basic understanding of a few exemplary embodiments and does not wholly define the breadth of the disclosure. This disclosure is not an extensive overview of all contemplated embodiments and is intended to neither identify key or critical elements of all embodiments nor to delineate the scope of any or all aspects. Its sole purpose is to present some features of one or more embodiments in a simplified form as a prelude to the more detailed description presented later. For convenience, the term “disclosed embodiments” or “exemplary embodiment” may be used herein to refer to a single embodiment or multiple embodiments of the disclosure.

In accordance with disclosed embodiments, a test collection device can be assembled and use for the testing of a surface for ATP, or another substance. Such testing may reduce or potentially eliminate the risk of contagion or illness from any pathogens contained in an environmental sample. For example, permanent containment of a sample within the test collection device can help prevent contact with the sample, greatly reducing the risk of contamination, contagion and illness.

In some embodiments, the test collection device has a detent that provides a tactile indication of a first configuration. According to some embodiments, a second configuration permanently locks the test collection device closed to contain the sample and prevent its escape.

In some embodiments, an exemplary test collection device can be used in healthcare settings to test environmental surfaces or a location on a patient's body. In some embodiments, the test collection device can be used in food preparation facilities to test environmental surfaces, containers or food products. In still further embodiments, the test collection device can be used to test any surface where it is desired to perform hygienic or sanitary testing for microorganisms or viruses.

In some embodiments, an exemplary test collection device may include a swab for collecting a sample from an environmental surface.

Further details and advantages of some exemplary embodiments shall now be discussed with reference to the drawings.

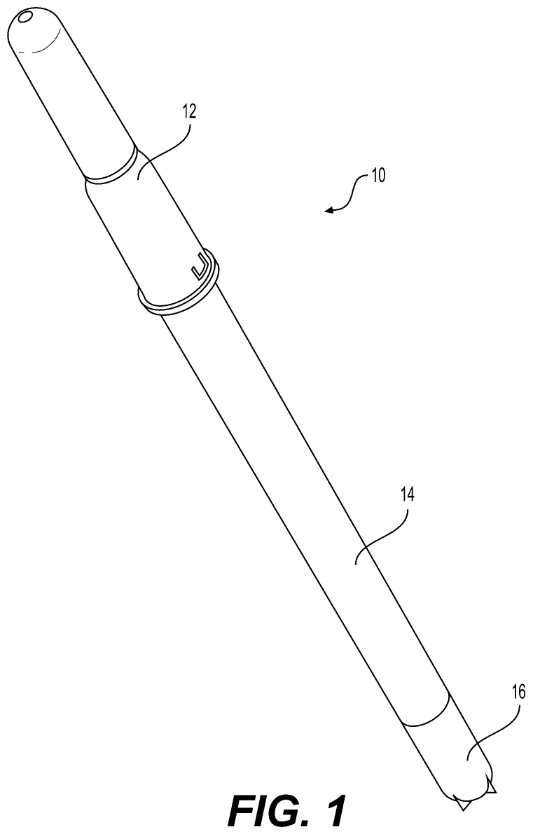

By way of example, FIG. 1 illustrates an exemplary embodiment of the test collection device 10 for collecting a sample, consistent with the present disclosure. In this exemplary embodiment, the test collection device 10 may include a venturi 12 which is connectable to a tube upper section 14. The tube upper section 14 is connectable to a lower tube cap 16.

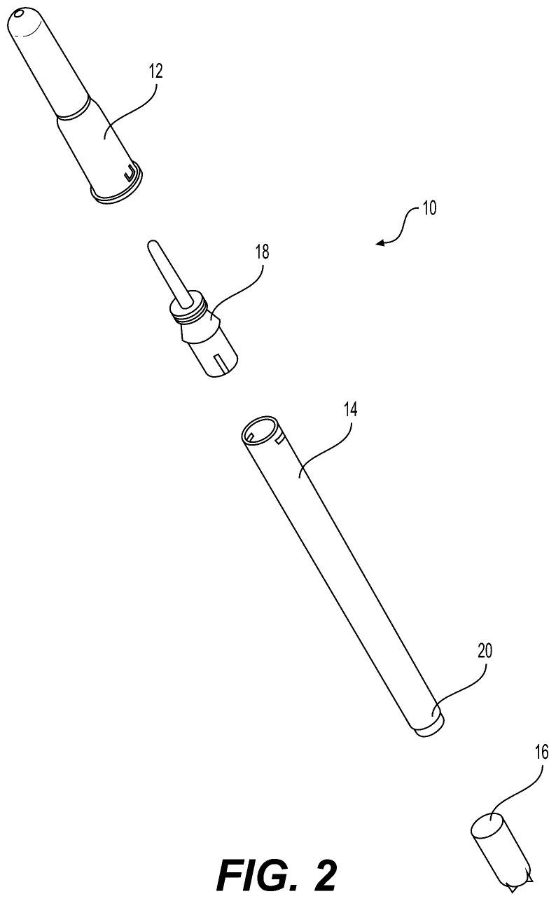

By further way of example, FIG. 2 illustrates an exploded view of the exemplary embodiment of the test collection device 10 shown in FIG. 1, consistent with the present disclosure. In this exemplary embodiment, the test collection device 10 may include a nib 18 which is connectable to a tube upper section 14. Advantageously, the nib can have a distinctive color for easy identification. The tube upper section 14 can also have a seal 20 where it is connectable to the lower tube cap 16. The seal is of a frangible material such as foil in illustrative embodiments.

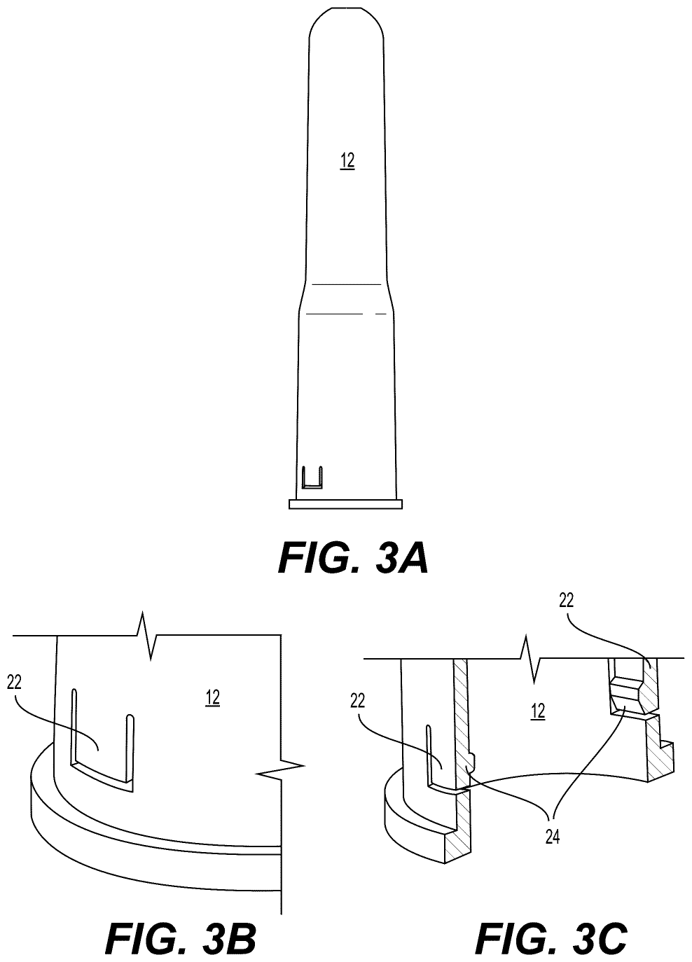

An illustrative venturi 12 is depicted further in FIG. 3A. At the lower end of venturi 12, one or more detent tab 22 is provided, as shown in FIG. 3B. In an illustrative embodiment, two tabs 22 are provided at opposite sides of the venturi 12, but any number of tabs with either equal or unequal spacing around the perimeter of the venturi 12 is possible. Advantageously, the tabs can provide a flexible spring force allowing deflection of the detent when the venturi 12 is joined with the tube upper section 14. As shown in FIG. 3C, a detent 24 is provided on the detent tab 22, consistent with the present disclosure.

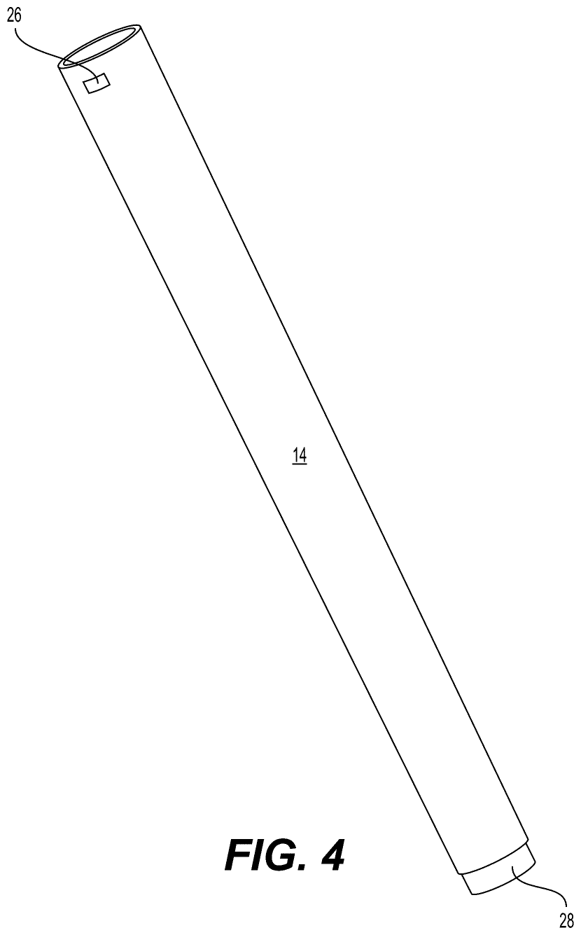

In some embodiments, as shown in FIG. 4, the tube upper section 14 of the test collection device 10 may include an opening 26. According to the present disclosure, the opening 26 is shaped and sized to receive the one or more detents 24 of venturi 12. Although only one opening 26 is illustrated, it is to be understood that upper tube section 14 or the test collection device 10 will include an adequate number of openings 26 to receive one or more of the detents 24 of venturi 12, consistent with the present disclosure. In some embodiments, tube upper section 14 can include a sealing surface 28 for joining with the lower tube cap 16. Although the sealing surface is shown as a step reduction in the radius of the tube upper section 14, any arrangement providing for a sealing fit is contemplated, consistent with the present disclosure.

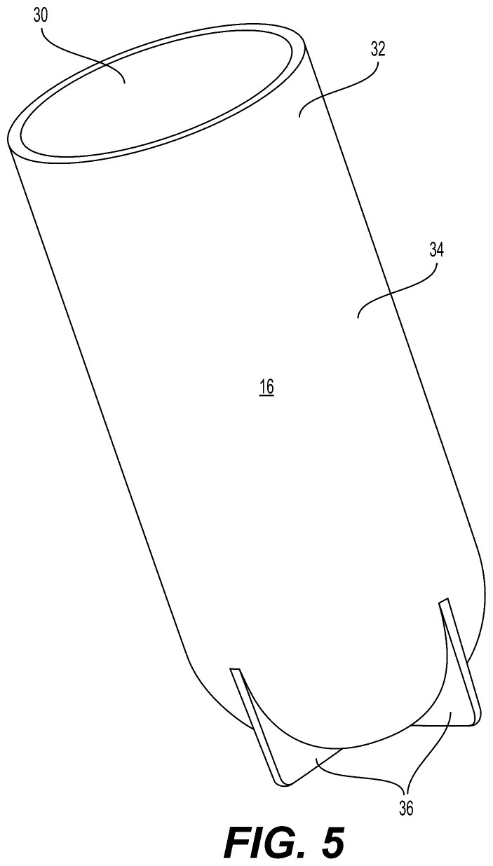

In exemplary embodiments, as shown in FIG. 5, the lower tube cap 16 of the test collection device 10 may include a sealing surface 30 for joining with the tube upper section 14. Any arrangement providing for a sealing fit with sealing surface 28 of the tube upper section 14 is contemplated, consistent with the present disclosure. Advantageously a frosted or translucent section 32 can be provided on lower tube cap 16. Further advantageously, a section 34 can be transparent to allow for visibility of the test reagent in use. In illustrative embodiments, a translucent section 32 and a transparent section 34 can provide for visual distinction of the two sections. According to the present disclosure, the tube lower cap 16 can include one or more lugs or fins 36 which can be held to prevent rotation of the lower tube cap, for example, when spin welding. Although the fins 36 are shown as flat and protruding features, any arrangement assisting in providing an anti-rotation grip is contemplated, consistent with the present disclosure.

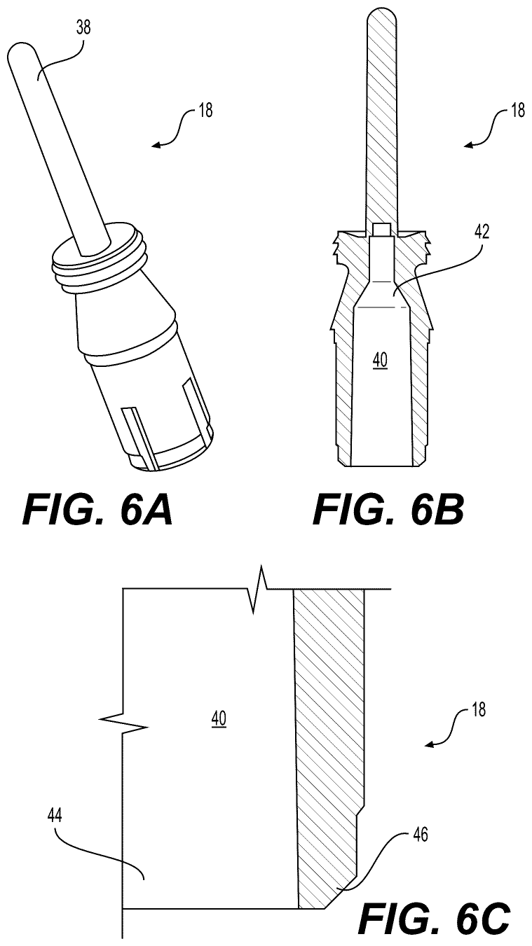

An illustrative nib 18 is depicted further in FIG. 6A. At the upper end of nib 18, a tip 38 is provided. The tip can extend into the venturi 12 as shown in FIG. 2. In some embodiments, as shown in FIG. 6B, nib 18 can have a cavity 40, with in some embodiments have a taper 42. In an illustrative embodiment shown in FIG. 6C, a lower end 44 of nib 18 can have a ramp surface 46, consistent with the present disclosure. In exemplary embodiments, the ramp surface 46 can be any configuration permitting a sliding engagement with the one or more detent 24 of venturi 12, as discussed further below.

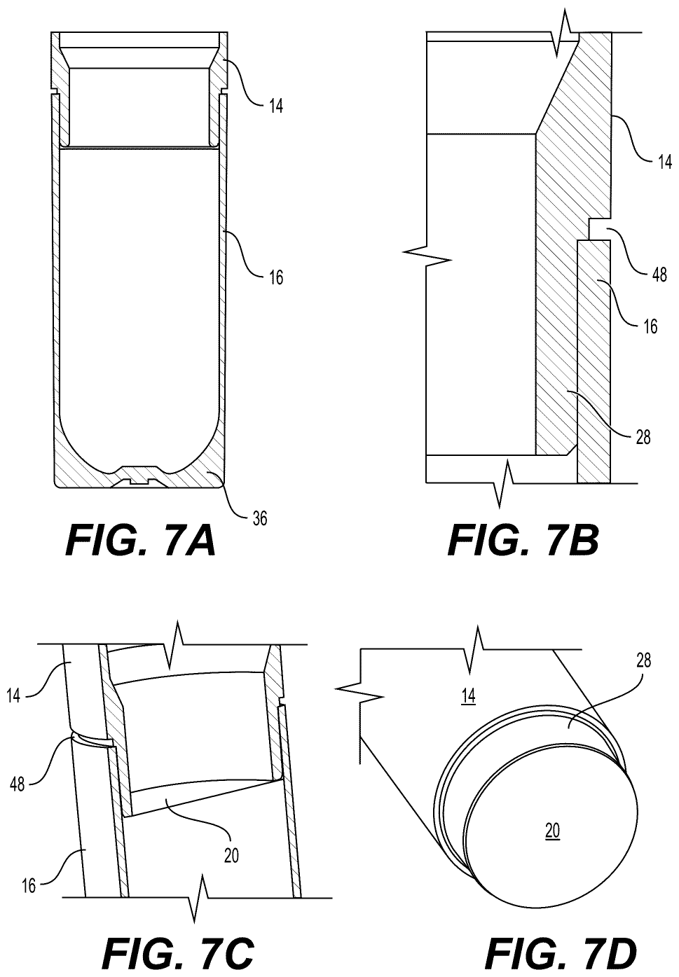

FIGS. 7A, 7B and 7C depict exemplary views of a tube upper section 14 joined with lower tube cap 16, consistent with some embodiments of the present disclosure. In some embodiments, as shown in FIG. 7B, the connection between tube upper section 14 and lower tube cap 16 can leave a gap 48. In some embodiments, the gap can be advantageous when spin welding the parts together, accommodating the flow of melted material for an enhanced seal. A perspective views of exemplary embodiments of joined tube upper section 14 and lower tube cap 16 with seal 20 is shown in in FIG. 7C. A further view of seal 20 along with sealing surface 28 of tube upper section 14 is shown in FIG. 7D.

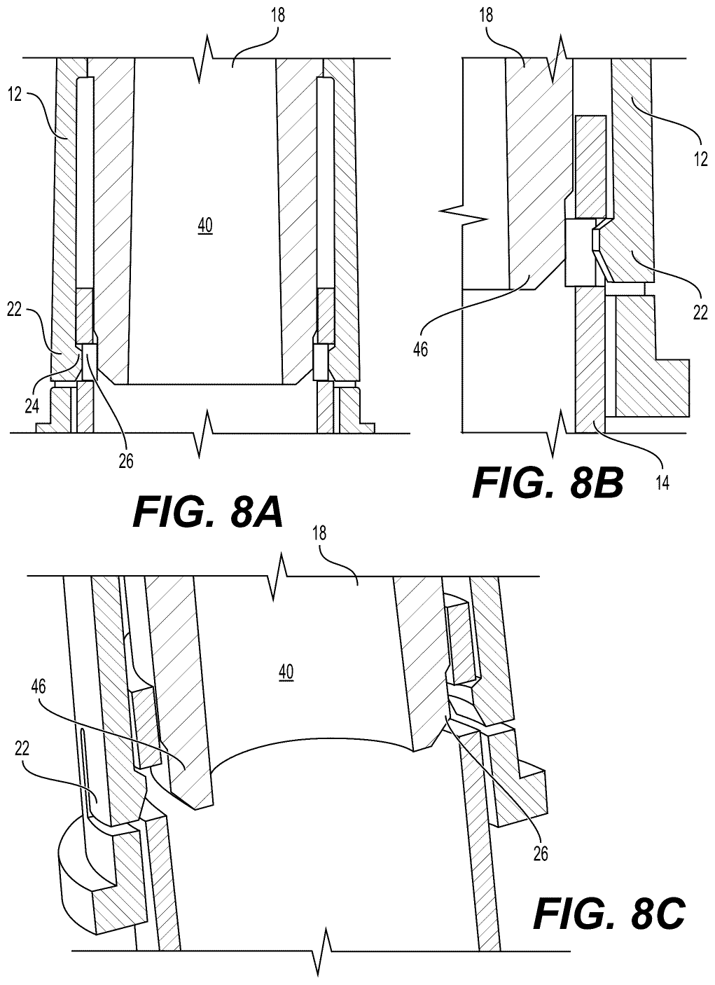

FIGS. 8A, 8B and 8C depict exemplary views of a tube upper section 14 joined with venturi 12, consistent with some embodiments of the present disclosure. In some embodiments, as shown in FIG. 8A, the connection between tube upper section 14 and venturi 12 allows detent tab 22 to bias detent 24 of venturi 12 into opening 26 to form a first, transport configuration. In some embodiments, the nib 18 can be cooperatively positioned such that ramp surface 46 accommodates detent 24 dwelling in opening 26, consistent with the present disclosure.

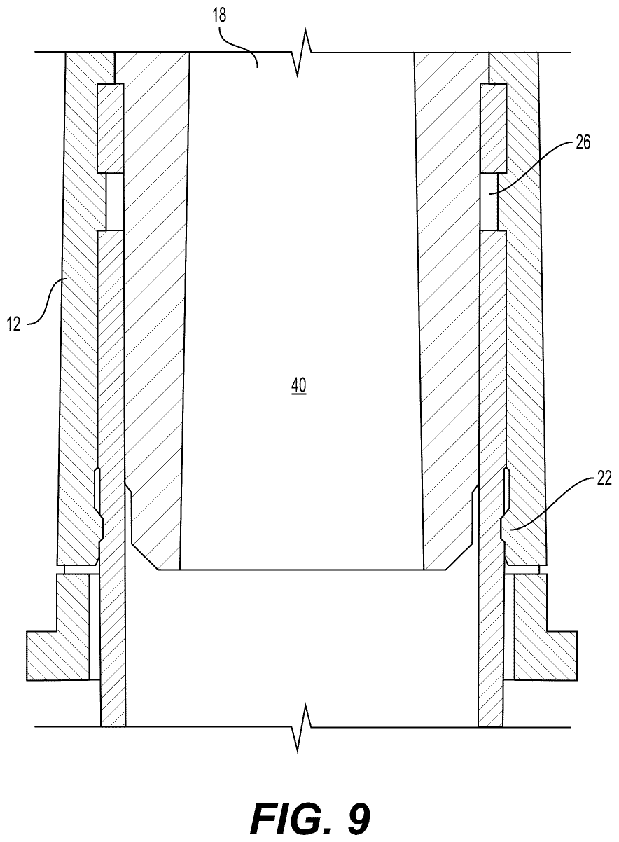

FIG. 9 depicts an exemplary views of a tube upper section 14 joined with venturi 12, consistent with some embodiments of the present disclosure. In some embodiments, the connection between tube upper section 14 and venturi 12 allows the bias of detent tab 22 to be overcome by advancing the tube upper section 14 into the venturi 12. In turn, detent 24 of venturi 12 is deflected out of opening 26, allowing the tube upper section 14 to form a second, function configuration. In some embodiments, the nib 18 can be cooperatively positioned such that ramp surface 46 urges detent 24 from opening 26, consistent with the present disclosure.

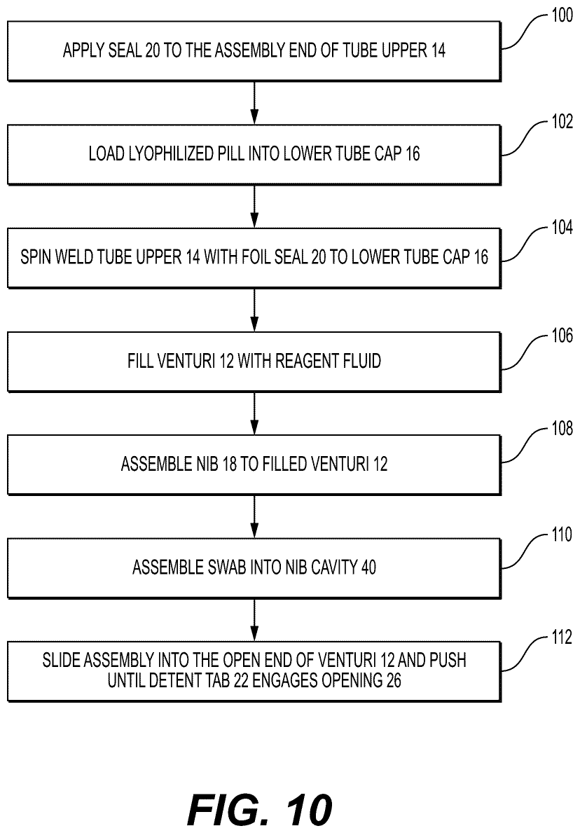

FIG. 10 depicts a flowchart of an exemplary process of assembling the exemplary collection device of FIG. 1, consistent with some embodiments of the present disclosure. In step 100, seal 20 is applied to the assembly end of tube upper section 14. At step 102, a reagent is loaded into lower tube cap 16, which in the illustrative process is a lyophilized pill. In some embodiments, the lyophilized pill is shelf-stable for storage. At step 104, tube upper 14 with foil seal 20 is spin welded to lower tube cap 16. At step 106, venturi 12 is filled with reagent fluid. At step 108, the nib 18 is assembled with the filled venturi 12. At step 110, a testing swab is assembled into nib cavity 40. At step 112, the assembly is slid into the open end of venturi 12 and advanced until detent tab 22 engages opening 26.

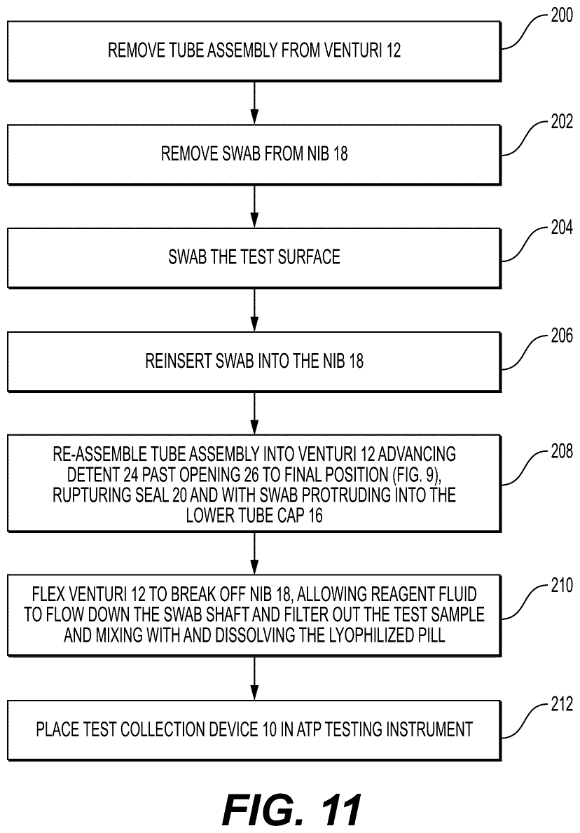

FIG. 11 depicts a flowchart of an exemplary process of using the exemplary collection device of FIG. 1 for testing, consistent with some embodiments of the present disclosure. At step 210, the tube assembly is removed from venturi 12. At step 202, the test swab is removed from nib 18. In illustrative methods, the swab has a distal test collection surface and a proximal handle section. At step 204, the test surface is swabbed. At step 206, the swab is reinserted into the nib 18. At step 208, the tube assembly is reassembled into venturi 12 advancing detent 24 past opening 26 to the final position illustrated in FIG. 9, thus rupturing seal 20 with the swab end protruding into the lower tube cap 16 At step 210, the venturi 12 is flexed to break off nib 18, allowing reagent fluid to flow down the swab shaft and filter out the test sample and mixing with and dissolving the lyophilized pill. At step 212, the test collection device 10 is placed into an ATP or other testing instrument for evaluation.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. In addition, while certain components have been described as being joined to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” or “top” and “bottom” are used only to differentiate a feature or operation from another feature or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that an embodiment may include A or B, then, unless specifically stated otherwise or infeasible, the stimulation pattern may include A, or B, or A and B.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation or restriction of the scope of the embodiments, the scope being defined by the following claims

1. A test collection device comprising:
A tube upper section and a lower tube cap;
the tube upper section comprising a seal at a lower end and one or more openings in the tube wall at an upper end;
the lower tube cap connected to the tube upper section configured to hold a dry reagent;
a venturi having an open end and containing reagent fluid;
the venturi having one or more detents configured to engage one or more of the openings of the upper tube;
a nib engaged with the venturi;
a swab;
wherein the upper tube is cooperatively received in the open end of the venturi.

2. The test collection device of claim 1, wherein the seal is frangible.

3. The test collection device of claim 2, wherein the seal comprises a foil.

4. The test collection device of claim 1, wherein the nib is frangible.

5. The test collection device of claim 1, wherein the detent further comprises a tab formed in the wall of the tube upper section.

6. The test collection device of claim 1, wherein the tube upper section and the lower tube cap have cooperative sealing surfaces.

7. The test collection device of claim 1, wherein the lower tube cap is spin welded to the tube upper section.

8. The test collection device of claim 1, wherein the lower tube cap further comprises a frosted section.

9. The test collection device of claim 1, wherein the lower tube cap further comprises a transparent section.

10. The test collection device of claim 4, wherein the nib further comprises a cavity, such that, in use, when the nib is fractured, the cavity is in communication with the venturi.

11. The test collection device of claim 10, wherein the cavity further comprises a taper.

12. The test collection device of claim 1, wherein the nib further comprises a ramp surface, wherein the ramp surface is configured to engage with the one or more detents.

13. The test collection device of claim 12 where in the ramp surface urges the one or more detents from the one or more openings in the tube upper section.

14. The test collection device of claim 1, further comprising a gap between the tube upper section and the lower tube cap.

15. The test collection device of claim 1, having a first configuration wherein the one or more detents are engaged in one or more openings in the tube upper section, and a second configuration, wherein the tube upper section is advanced into the venturi with the one or more detents disengaged from the one or more openings in the upper tube section.

16. The test collection device of claim 12, having a first configuration wherein the one or more detents are engaged in one or more openings in the tube upper section, and a second configuration, wherein the tube upper section is advanced into the venturi with the one or more detents disengaged from the one or more openings in the upper tube section, wherein the ramp surface of the nib urges the detents from the openings when the upper section is advanced into the venturi.

17. The test collection device of claim 1, wherein the dry reagent is lyophilized.

18. The test collection device of claim 17, wherein the reagent is a pill.

19. A method of making a test collection device comprising:
applying a seal to a first end of a tube upper section;
loading a reagent into a lower tube cap;
joining tube upper section to the lower tube cap 16;
filling a venturi with reagent fluid;
assembling the nib with the filled venturi;
assembling a testing swab into nib cavity;
sliding the assembly into an open end of the venturi; and
advanced the assembly until a detent tab on the venturi engages opening on the tube upper section.

20. The method of claim 19, where in the joining step further comprises spin welding.

21. A method for collecting a sample for testing, comprising:
removing a tube assembly from a venturi of a sample collection device;
removing a swab from a nib connected to the venturi;
swabbing a testing surface with the swab;
reinserting the swab into the nib;
replacing the tube into the venturi; wherein a foil seal is ruptured by the swab.

22. The method of claim 21, further comprising the steps of:
flexing the venturi to fracture the nib, allowing reagent fluid to flow down the swab shaft, wherein the reagent fluid is filtered and mixed with a reagent.
